(19) United States
(12) Patent Application Publication
(10) Pub. No.: US 2026/0061664 A1
(43) Pub. Date: Mar. 5, 2026

(54) Vapor Cooling 3D Printing for Bio Active and Heat Labile Materials

(71) Applicant: Manuel R Rendon, Winter Springs, FL (US)

(72) Inventor: Manuel R Rendon, Winter Springs, FL (US)

(73) Assignee: Manuel R Rendon, Winter Springs, FL (US)

(21) Appl. No.: 19/310,058

(22) Filed: Aug. 26, 2025

(51) Int. Cl. B29B 9/06; B29B 9/16; B29C 48/05; B29C 48/36; B29K 29/00; B33Y 40/10; B33Y 70/10; B33Y 80/00; C08J 3/075; C11D 9/22; C11D 9/26; C11D 9/44; C11D 13/18

(52) U.S. Cl. CPC B29B 9/06; B29C 48/05; B29C 48/36; B33Y 40/10; B33Y 70/10; B33Y 80/00; C08J 3/075; C11D 9/225; C11D 9/265; C11D 9/442; C11D 13/18; B29B 2009/168; B29K 2029/04; B29K 2995/0017; C08J 2329/04

(57) ABSTRACT

A method and material for 3D printing objects containing heat-sensitive molecules are disclosed. The composition consists of a water-saturated, polar thermoplastic polymer, such as highly hydrolyzed polyvinyl alcohol (PVA), into which functional molecules—proteins, peptides, pharmaceuticals, fragrances, or living cells—are dispersed. The polymer is first hydrated to form a gel, extruded and cut into pellets, then partially dried through a multi-stage dehydration process that leaves a moisture-rich core and a dry outer shell. During extrusion at typical FDM nozzle temperatures (≈200° C.), entrapped water within the material vaporizes at ≈100° C., providing in situ evaporative cooling and maintaining the temperature of the functional molecules below their degradation point. The process enables additive manufacturing of structurally sound objects that preserve the activity of heat-sensitive additives, opening new applications for 3D-printed consumables, pharmaceuticals, and bio-functional components.

### BACKGROUND OF THE INVENTION

Conventional consumer 3D printers (especially Fused Deposition Modeling, FDM, printers) typically operate by melting thermoplastic materials at temperatures around 200° C. This high extrusion temperature poses a significant challenge when attempting to 3D-print objects that contain heat-sensitive molecules (e.g., proteins, enzymes, pharmaceuticals, amino acids, essential oils, fragrances, etc.). Such functional molecules tend to denature or decompose when exposed to the ˜200 ° C. heat of a standard printer nozzle, losing their functionality. For example, a soap's active surfactants will burn and cease functioning if heated to typical extrusion temperatures, and a cinnamon powder's volatile aromatic compounds will degrade, eliminating its scent. Similarly, many pharmaceutical compounds lose therapeutic efficacy if subjected to such high heat. As a result, very few 3D-printable biomaterials or functional materials exist today—the 3D printing industry is largely limited to inert plastics. This severely hinders the ability to create objects that are more than just structural in purpose. In other words, current 3D printing methods cannot easily produce items like medicinal patches with active drugs, scented or flavored objects, or protein-based components, because the act of printing destroys the very molecules that give those objects their function. This is a major limitation preventing 3D printers from moving beyond purely geometric fabrication into producing functionally enhanced objects for everyday use.

Furthermore, traditional mass-manufacturing versus on-demand 3D printing presents an environmental and efficiency trade-off. Large-scale manufacturing processes often require high energy input and produce significant waste or surplus products (leading to pollution, including plastic and microplastic waste). In contrast, 3D printing is an energy-efficient, additive process: material is deposited only where needed, and only a small volume (e.g., the nozzle area) is heated at a time. If 3D printing could be expanded to handle a wide variety of functional materials (including sensitive biological or chemical additives), it could enable on-demand production of complex functional items at the point of need. This in turn would reduce reliance on mass production and potentially mitigate plastic pollution and waste, since consumers or healthcare providers could print exactly what is required, when it is required, with minimal excess.

The next revolutionary step in personal manufacturing would thus be the ability to 3D-print objects containing active, heat-sensitive molecules without destroying their activity. However, achieving this requires a way to protect sensitive components from heat during the printing process. To date, there has been no known solution that allows standard high-temperature 3D printers to process a broad range of molecules regardless of heat sensitivity—this is the problem the present invention addresses.

### SUMMARY OF THE INVENTION

The invention provides a method and material system that enables heat-sensitive molecules to be 3D-printed using conventional thermoplastic extrusion (FDM) equipment by incorporating an internal cooling mechanism directly into the print material itself. In summary, a polar thermoplastic polymer (preferably polyvinyl alcohol, PVA, or a similar hydrophilic polymer) is saturated with water to create a water-rich carrier matrix. This water-saturated polymer is then processed (e.g., pelletized and conditioned) such that it retains a significant quantity of water within its structure. When heat-sensitive molecules (such as the aforementioned proteins, enzymes, pharmaceuticals, amino acids, essential oils, or other temperature-sensitive compounds) are mixed into this prepared polymer matrix and the composite is extruded for 3D printing at typical nozzle temperatures (˜190-220 ° C.), the embedded water absorbs the heat of extrusion by vaporizing into steam. The endothermic evaporation of the internal water effectively regulates and limits the temperature experienced by the sensitive molecules, preventing them from reaching their degradation point. In essence, the water acts as a built-in thermal buffer or cooling agent: as it evaporates, it carries away excess thermal energy (via its high latent heat of vaporization) and thus serves as an enthalpic buffer, thereby protecting the sensitive additives from denaturation or burning. As a result, the functional molecules remain intact and active throughout the printing process and in the final printed object.

Key aspects of the invention include both the material composition and the preparation process:
Water-Loaded Thermoplastic Carrier: A highly hydrolyzed PVA (polyvinyl alcohol) or similar polar thermoplastic polymer is used as the base matrix. PVA is chosen for its strong affinity for water (it forms a hydrogel via extensive hydrogen bonding with water) and its compatibility with standard 3D printers. The polymer is loaded with a large amount of water (for example, on the order of 50-70% by weight water content when fully saturated) in such a way that the water is predominantly retained within the polymer matrix until intentionally released by heating. This forms a kind of “wet” filament or pellet that contains substantial internal moisture, referred to as structured water when bound within the polymer's structure. The water is held at a molecular level within the polymer (rather than just as surface moisture), so it remains in place until heating, and the carrier can still be handled similarly to a normal thermoplastic material.
Thermal Protection via Evaporation: During 3D printing extrusion, as the composite material (polymer+water+sensitive molecule) is heated in the printer's hot end, the internal water begins to evaporate around its boiling point (˜100 ° C.), absorbing a great deal of heat in the process. This phase change cooling mechanism keeps the local temperature of the mixture near the boiling point of water (˜100 ° C.) until most of the water has vaporized, rather than allowing the polymer and additives to all climb to the full nozzle temperature (˜200 ° C.). Thus, the sensitive additive is largely maintained at a significantly lower temperature than the bulk heater setting, preventing thermal damage. Essentially, the invention turns what is normally an undesirable filament moisture content into a beneficial in situ cooling system (steam generation within the material). The vaporization of water (with its high heat of vaporization) clamps the material's temperature at an additive-safe level during extrusion. By the time the water is fully evaporated, the polymer and additives are already exiting the nozzle in the form of extruded filament, so the additives never experience the higher temperatures long enough to be destroyed.
Process for Preparing the Material: The invention outlines a method to create the water-rich filament or pellet feedstock with the proper internal water distribution:
   1. Hydrate the Polymer: Start with a dry polar thermoplastic polymer (e.g., PVA, preferably fully or highly hydrolyzed such as 98%+hydrolyzed grade). Saturate the polymer with water to form a water-infused polymer gel. This can be achieved by mixing the PVA powder with water or exposing it to a high-humidity environment until the polymer absorbs as much water as possible. For instance, PVA powder can be misted or soaked so that it swells into a gel containing approximately 50-70% water by weight. It is important that water permeates the polymer thoroughly (creating a uniform hydrogel) rather than just wetting the surface. Through hydrogen bonding and polymer chain interactions, water molecules become integrated into the polymer network (so-called “structured water” bound within the polymer matrix). The polymer chains in this state are well-hydrated and the material is swollen and pliable.
   2. Form into Pellets or Filament: Next, form the water-infused polymer into pieces suitable for use as 3D printer feedstock. One convenient form is pellets. The hydrated PVA mass (which is paste-like or gel-like) is fed into an extruder (for example, a single-screw or twin-screw extruder configured to handle high-moisture materials). The extruder is operated at a moderate temperature (on the order of 50-100° C., just enough to convey the material, in order to avoid prematurely boiling off the water). The water-rich polymer is extruded through a die into strand(s) which are immediately cut by a rotating cutter at the die face, producing small pellets (element 150 in FIG. 1). These freshly cut pellets are soft and contain a large amount of internal water. (Alternatively, if one wanted to produce a continuous filament directly, a 1.75 mm or 2.85 mm diameter strand could be extruded and cooled. However, handling a filament with such high water content is challenging —it may be very flexible, and if not kept cooled, it can bubble from the water—so the pellet approach with subsequent conditioning is generally more robust for manufacturing and handling purposes.)
   3. Controlled Partial Drying (Dehydration Conditioning): A key step of the process is to partially dry and condition the pellets in order to achieve the optimal moisture distribution (moist core with stable dry surface). Immediately after pelletization, the pellets may be uniformly saturated and even surface-wet, which would make them too tacky or cause excessive foaming if used as-is. The invention employs a controlled drying process using a multi-stage dehydration tower (160 in FIG. 1) to gradually remove surface moisture while retaining water in the core. The freshly made pellets (still roughly 50-70% water by weight internally) are loaded into the top of a vertical tower with multiple perforated trays (170 in FIG. 1). The tower is heated, creating a temperature gradient from bottom to top (similar in principle to a fractional distillation column). For example, the bottom of the tower may be heated to around 100-130° C. (say ˜120 ° C.), which causes pellets on the lowest tray (155 in FIG. 1) to give off some of their water as hot vapor. This water vapor rises upward (indicated by arrows 180) through the perforations to higher levels of the tower. The upper trays are maintained at a lower temperature (for instance, the top sections might be at ˜57-75 ° C.), so as the vapor reaches the pellets on upper trays (190 in FIG. 1), those cooler pellets absorb moisture from the vapor. In essence, water is redistributed: the wettest pellets (at the bottom) lose some moisture, and the initially drier pellets at the top reabsorb moisture internally from the humid vapor. Over time, and possibly with movement or mixing of pellets to ensure even conditioning, the pellets reach an equilibrium moisture distribution. The goal is to achieve an intermediate water content throughout each pellet—for example, on the order of 20-40% by weight water—such that each pellet has a moisture-rich interior but a dry, solid outer surface. The slight drying at the surface may cause the pellet's exterior to form a firm “skin” (as shown at 310 in FIG. 2) that is not tacky and can be handled like a normal plastic pellet, while the inside remains gel-like and water-saturated (320 in FIG. 2). By the end of this dehydration-conditioning step, the conditioned pellets (195 in FIG. 1) are free-flowing and stable externally, yet contain substantial entrapped water in their core. The pellets are then gently cooled to room temperature (to avoid condensation of ambient moisture on them) and stored in a moisture-sealed container until use.
   4. Introduce Heat-Sensitive Additives: Once the carrier pellets are prepared and cooled, they are combined with the desired heat-sensitive molecules to form a functional composite material. Depending on the nature of the additive, different techniques can be used:
      If the additive is a dry powder (e.g., a powdered drug, vitamin, flavorant, or enzyme), a straightforward method is to tumble-mix the powder with the conditioned pellets. The pellets'dry outer surface allows the fine powder to coat them without immediately dissolving. This powder-coated pellet mixture can then be melt-processed (either fed into a filament extruder or directly into a pellet-fed 3D printer) so that the powder disperses into the molten polymer during extrusion. Crucially, when melting occurs, the water inside the pellets will boil and protect the additive from excessive heat.
      If the additive is a liquid or solution (e.g., a vitamin solution, essential oil fragrance, or a suspension of living cells for bioprinting), one can infuse the additive into the pellets by soaking or injecting. The hydrophilic pellets will absorb some of the liquid if exposed briefly (care must be taken that the soaking time and solution properties do not dissolve or overly soften the pellet). Alternatively, for certain additives that can tolerate earlier processing, the additive could be mixed into the PVA-water gel before pelletization so that it is already embedded in the polymer matrix; however, very sensitive additives are generally better introduced after the dehydration step to avoid any thermal or dehydration stress. In either case, after infusion, the excess surface liquid can be drained or dried so the pellets remain free-flowing.
      In another embodiment, a co-extrusion or coating approach is used: for example, one can extrude the water-rich pellets into a filament while simultaneously introducing the heat-sensitive substance via a coaxial feed (so that the additive is incorporated into the filament's core), or by passing the freshly extruded filament through a bath or coating solution containing the additive. This way, the additive either gets embedded in the filament core or coated onto the filament without being subjected to high temperatures. Such techniques can ensure uniform distribution of very sensitive additives, though they require more specialized equipment.
      In a simple practical scenario, the user or manufacturer can perform a just-in-time mixing of the additive with the pellets. For instance, one can manually blend a measured amount of functional pellets with a powdered additive in the hopper of a printer, or use a feeder attachment that mixes an additive into the pellet flow right before extrusion. The composite is then fed into the printer's hot end for direct printing. This approach emphasizes that no elaborate modification of the printer is required—the protective effect comes from the material itself.
   5. 3D Printing the Composite Material: The final composite material (the moisture-conditioned polymer loaded with the heat-sensitive additive) can be printed using a standard FDM 3D printer with minimal modifications. If the material has been formed into a filament, it can be fed into a regular filament-fed printer; if it remains as pellets, a pellet-fed extrusion system can be used (certain industrial FDM printers or modified desktop machines can print directly from pellets). In either case, the printer's nozzle is typically set in the normal range for the polymer (for PVA, around 190-210° C.). As the composite enters the heated nozzle and begins to melt, the entrapped water inside each pellet or filament segment starts to boil off once the temperature reaches approximately 100° C. The phase-change of water from liquid to vapor absorbs a large quantity of heat (˜2260 J per gram of water vaporized), effectively buffering the temperature of the surrounding polymer melt around the boiling point of water. In other words, the region of material in the nozzle stays near ˜100 ° C. as long as water remains to evaporate, even though the heating element is trying to raise it to around 200° C. By the time the internal water is mostly exhausted (converted to steam), the material has traveled through and out of the nozzle orifice as an extruded bead (see FIG. 3). At that point, the polymer (now largely water-free) quickly solidifies as it cools, being deposited as part of the printed layer, and the heat-sensitive molecules become embedded in the solid polymer matrix of the printed object. Throughout this process, the sensitive additive has been maintained at substantially below the nozzle temperature—often at or under ˜100 ° C.—and therefore avoids the thermal degradation it would normally suffer at 190-200° C. This allows the additive to remain active and functional in the final printed item.

Through this innovative water-saturated carrier approach, the invention dramatically broadens the range of materials that can be 3D-printed. Using this system, applications become possible that were previously impractical or impossible. For example, medical and pharmaceutical applications are enabled: one can print personalized drug doses, drug-eluting implants, or biomedical devices with active therapeutics included, without destroying the drug compounds. Similarly, biofabrication and food applications become feasible—one could print with proteins, enzymes, probiotics, vitamins, or flavors, retaining their biological activity or nutritional value. In the realm of cosmetics and consumer goods, one can print items like soaps or cosmetics with active skincare ingredients, or scented objects that actually release fragrance, with those functional additives intact. Even educational or decorative objects incorporating fragile biological materials (such as living cells, bacteria, or heat-sensitive dyes and aromas) can be created. The printed objects not only have the desired 3D shape but also preserve the functionality of the included sensitive components. All of this is achieved without requiring any modification to the 3D printer hardware—the solution is entirely in the material composition and preparation. The invention is therefore broadly compatible with existing FDM machines and can be adopted readily. To our knowledge, this is the first method that enables standard high-temperature 3D printing of delicate, heat-sensitive molecules by leveraging the material's own internal phase-change cooling mechanism. The result is a versatile platform for 3D printing functional materials that previously could not be printed due to heat sensitivity, representing a significant advancement in the field of additive manufacturing.

### BRIEF DESCRIPTION OF THE DRAWINGS

To further illustrate the invention, the following conceptual diagrams are described in lieu of formal drawings (the diagrams are presented in textual form with figure numbers, as no formal images are provided):

FIG. 1: Schematic of Material Preparation Process. FIG. 1 depicts a flow diagram of the process for preparing the water-saturated polymer carrier and integrating a sensitive molecule. Starting from PVA powder (110) being combined with water (120) to form a hydrated mixture or gel (130), the figure shows extrusion of this mixture through an extruder (140) to form polymer strands that are cut into pellets (150). These pellets are then fed into a multi-stage dehydration tower (160) containing several perforated trays (170). Arrow (180) in the diagram indicate the flow of water vapor rising from the lower trays to the upper trays. Upper-tray pellets (190) absorb the rising vapor and remain highly hydrated internally, while lower-tray pellets (155) gradually dry out externally. After cooling, the conditioned pellets (195) are collected and later mixed with a sensitive-to-heat additives (200) to form the final composite feed material (210) that is ready for 3D printing.

FIG. 2: Cross-Section of a Moisture-Retaining Pellet. FIG. 2 illustrates a single pellet (300) of the water-saturated polymer after the dehydration conditioning process. The pellet has a dry outer shell or surface (310) and a moist inner core (320). Different shading is used conceptually to indicate that the interior of the pellet contains entrapped water, whereas the exterior is more solid and dry. This core-shell structure allows the pellet to be handled and fed like a normal plastic pellet, thanks to the dry, firm outer layer, but still retain significant internal moisture that will be released upon heating during printing.

FIG. 3: 3D Printing with the Water-Saturated Material. FIG. 3 shows a standard FDM 3D printer nozzle (400) extruding the composite material (420) that contains the sensitive molecules (430) dispersed within the molten filament and entrained water. As the material is heated in the nozzle, water vapor (steam) is released from the melt. The steam escapes through the nozzle alongside the extruded bead. Even though the nozzle's heating element is set around ˜200 ° C., the vapor-surrounding material stays around ˜100° C. due to the boiling of water. Downstream of the nozzle, a final printed strand (440) is deposited, containing the sensitive molecules intact within the polymer matrix.

### DETAILED DESCRIPTION OF THE INVENTION

### Overview

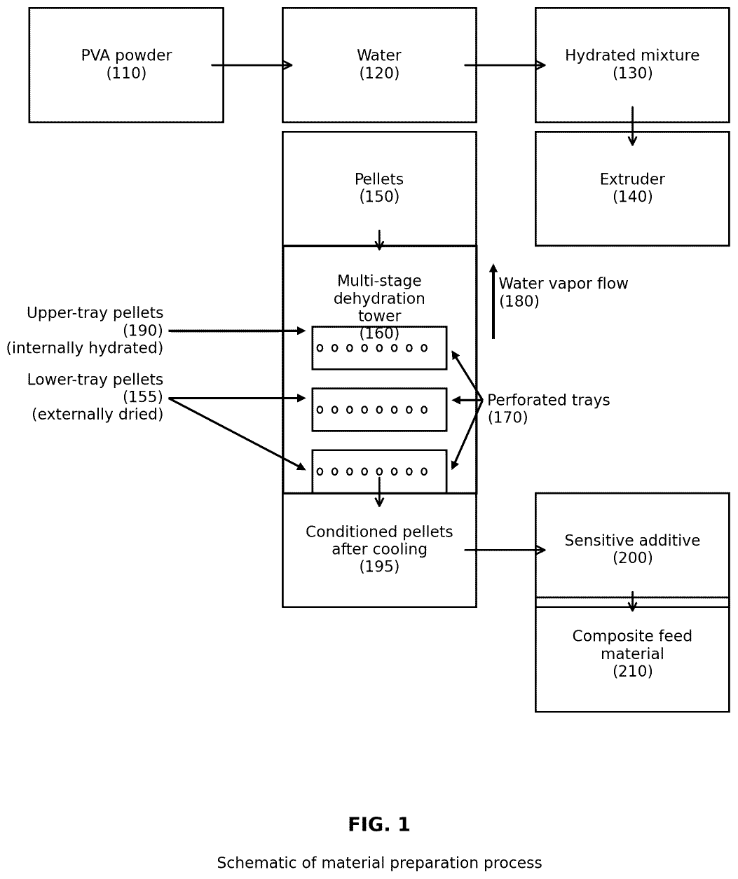

The invention will now be described in detail with reference to example embodiments illustrated by FIGS. 1-3. These examples are provided for explanatory purposes and are not intended to limit the scope of the invention. Variations and equivalent steps or elements, as will be apparent to those skilled in the art of materials science and additive manufacturing, are considered within the scope of the invention. All temperatures in this document are given in degrees Celsius unless otherwise noted (with some Fahrenheit equivalents provided for convenience).

### Material Selection—Polymer Matrix

The base material for the carrier is a polar, water-compatible thermoplastic polymer. In the preferred embodiment, this is polyvinyl alcohol (PVA), particularly a highly hydrolyzed grade (for example, 98%+hydrolyzed). Highly hydrolyzed PVA is essentially fully alcoholized (with most acetate groups converted to alcohol groups), making it very hydrophili—it can absorb a large amount of water and form a gel (indeed, fully hydrolyzed PVA is water-soluble to a degree). PVA also processes well in standard 3D printers, melting in the range of about 190-220° C., and is non-toxic and biodegradable, which is advantageous for medical or consumer product uses. Other candidate polymers that have the necessary properties (the ability to absorb and retain water, and a melt-processing temperature in roughly the 150-220° C. range) could include, for example, polyvinylpyrrolidone (PVP), certain hydrophilic cellulose derivatives or gums, gelatin and other thermoplastic biopolymers, or various polymer blends designed for water uptake. However, for simplicity and proven effectiveness, the description and examples herein focus on PVA as the carrier polymer.

### Preparing a Water-Saturated Polymer

To load the polymer with water (thereby creating the internally cooling carrier), the polymer can start in a dry powder or granular form. One embodiment involves exposing PVA powder to water until saturation. For instance, the PVA can be spread in a chamber with controlled high humidity or directly mixed/sprayed with water to allow it to absorb as much water as possible. As the PVA takes up water, it transitions from a free-flowing powder into a swollen, gelatinous mass. At high water contents (on the order of 50-70% water by weight), the polymer forms a thick hydrogel or paste. It is important that the water is absorbed into the polymer matrix rather than just wetting the outside; the goal is a uniform distribution of water molecules among the polymer chains. In this state, water molecules are held within the polymer structure by hydrogen bonding and other molecular interactions (hence the earlier use of the term “structured water”). The water is essentially part of the polymer network, not merely surface moisture. By thoroughly saturating the PVA in this manner, we ensure that the polymer chains are well-hydrated and the material is in a swollen state ready for further processing.

### Forming Pellets or Filament

The water-saturated PVA polymer is then formed into a shape suitable for use as 3D printer feedstock. In a preferred approach, the material is formed into pellets for ease of handling. The hydration-softened PVA gel is fed into an extruder (this could be a single-screw or twin-screw extruder designed to handle high-moisture content materials). The extruder is run at a relatively low temperature (for example, approximately 50-100° C., just enough to drive the material forward and through the die, but not hot enough to cause significant water boil-off). The PVA gel is extruded through a die, emerging as strands (resembling spaghetti) which are immediately cut into short segments by a rotating cutter at the die face. These segments form the pellets (item 150 in FIG. 1). The freshly cut pellets are soft, pliable, and contain a substantial amount of water internally.

Alternatively, a continuous filament could be directly extruded by using a small-diameter die (e.g., to produce a 1.75 mm or 2.85 mm filament for direct use). The filament would then be cooled to maintain its form. However, managing a filament that contains such a high fraction of water is difficult: it may be mechanically weak or very flexible (due to the plasticizing effect of water), and if any section of it is overheated or not kept under tension, the water could cause bubbling and foaming. Thus, from a manufacturing and usability standpoint, the pellet approach followed by a conditioning step is preferred for creating a reliable feedstock.

### Dehydration Tower Conditioning

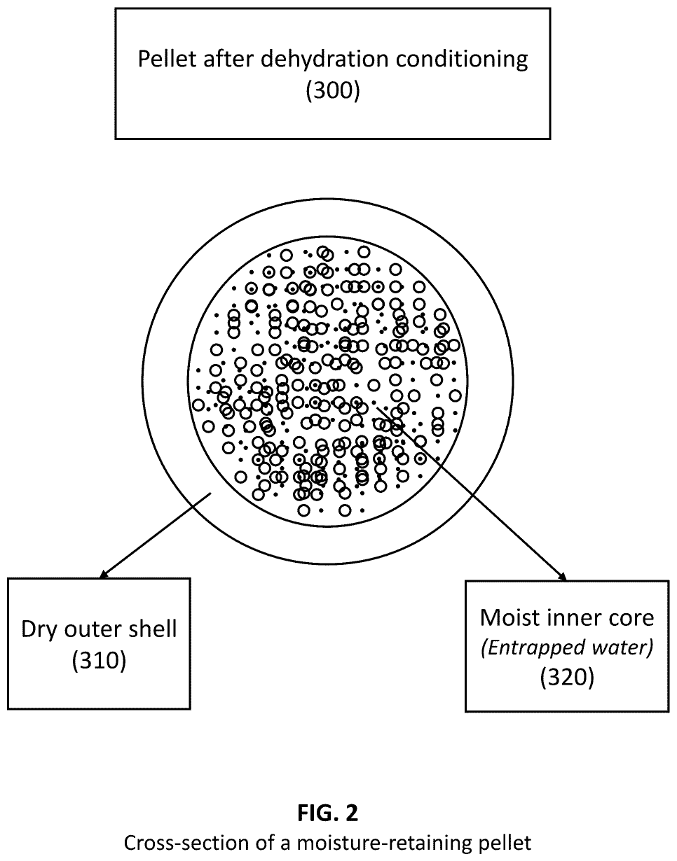

After pelletization, the pellets must be conditioned to have the right amount and distribution of moisture. If one attempted to use the pellets immediately after they were made (when they might be ˜60% water throughout and even wet on the surface), several problems would arise: the pellets could stick together, deform under their own weight, and when heated in a printer, would release a large burst of steam at the surface, causing foaming and voids in the extrudate. The invention overcomes this by carefully partially drying the pellets in a controlled manner to create a moist-core/dry-surface structure (as depicted in FIG. 2).

The conditioning is done in a dehydration tower (160 in FIG. 1), which is essentially a vertically oriented drying column with multiple perforated trays. The freshly extruded pellets are loaded into the top of the tower. Heat is applied either from the bottom or in stages along the tower to establish a thermal gradient. For example, the bottom section of the tower may be heated to around 120° C. (approximately 250° F.). Pellets on the bottom tray (155) get heated and begin to lose water; water vapor is driven out of these bottom pellets. This hot, moist air (water vapor) rises upward through the perforations (as indicated by arrows 180). Meanwhile, the upper parts of the tower are maintained at a lower temperature—for instance, the top trays might be held at around 60° C. (140° F.) or thereabouts. As the warm, moisture-laden air rises and encounters the cooler pellets on the upper trays (190), those pellets tend to absorb some of that moisture (because cooler, drier pellets will take up water from humid air). In effect, the tower operates like a moisture redistribution system: the driest pellets (initially those placed at the top) gain moisture from the vapor, and the wettest pellets (those at the bottom) shed moisture. Over time (and possibly with occasional stirring or movement of pellets between trays to ensure even treatment), the pellets approach a target moisture content profile.

By the end of this process, each pellet ideally has an intermediate overall water content—for example, roughly 20-30% by weight on average—with a dry outer layer. In practical terms, this might mean the surface 100-200 microns of the pellet is drier and slightly shrunken, forming a firm skin (310 in FIG. 2), while the inner core remains hydrated (320 in FIG. 2). The precise target moisture can be tuned (for instance, one might aim for pellets having between about 10% and 40% internal water content, depending on the application). The key is that there is enough water retained to provide cooling during printing, but not so much that the pellet is soft, sticky, or unstable. The pellets at the very bottom of the tower may become quite dry (since they give off a lot of moisture); those could either be recycled (re-hydrated and reprocessed) or gradually conveyed upward in a continuous system. In some implementations, the drying tower can be a continuous counter-current system where pellets slowly move from top to bottom while hot air moves from bottom to top, achieving the same effect. The end result is a batch of conditioned pellets (195) that have a dry, free-flowing exterior suitable for storage and feeding, combined with a moisture-rich interior ready to act as a heat sink during extrusion. After conditioning, the pellets are allowed to cool to ambient temperature (to avoid immediate condensation of atmospheric humidity on them when exposed to air) and are stored in an airtight container or bag to preserve their moisture content until they are mixed with the additives and used.

### Incorporating the Sensitive Molecules

Once the carrier pellets have been prepared as described above and have cooled to room temperature, they are ready to serve as a vehicle for the heat-sensitive additives. Depending on the type of sensitive molecule or compound to be printed, there are several techniques for integrating the additive into the carrier matrix:
Dry powder additives: Many active ingredients can be provided as dry powders (for example, certain drugs, vitamins, flavor powders, powdered enzymes, dried probiotic bacteria, etc.). In such cases, a simple and effective method is to coat the conditioned pellets with the powder. This can be done by placing the pellets and the additive powder together in a tumbler or mixer and gently agitating them (tumble-mixing) so that the fine powder adheres to the outer surfaces of the pellets. Because the pellets have a dry outer shell, the powder will not immediately dissolve or cause clumping; it stays on the surface. When these powder-coated pellets are later heated and extruded (to form a filament or directly in a printer), the powder will mix into the melting polymer. At that moment, the water inside the pellet will begin vaporizing and protect the now-entrained additive from the heat. This method is straightforward and avoids exposing the additive to any significant processing steps prior to printing.
Liquid or solution additives: If the additive is in liquid form (for example, a concentrated solution of a drug, a fragrance oil, a suspension of cells, or any other liquid formulation), the pellets can be infused or soaked with the liquid. One approach is to spray the liquid onto the pellets and let them sit briefly, allowing the liquid to absorb into the pellet cores (PVA pellets, being hydrophilic, can take up some of the liquid, especially if the liquid is water-based). Another approach is to use a vacuum infiltration, where pellets and liquid are placed under vacuum and then returned to atmospheric pressure to draw the liquid into the pellet pores. Care must be taken not to oversaturate or dissolve the pellet's surface. After infusion, any excess surface liquid can be drained and the pellets dried superficially so they remain easy to handle. In cases where the additive can tolerate it, another strategy is to introduce the additive earlier in the process—for example, mixing the additive into the PVA-water gel before pelletizing, so that the additive is inherently embedded in each pellet. However, this is only feasible if the additive will not be harmed by the pellet formation and drying process (some delicate biomolecules might not survive the heating to ˜60-120 ° C. in the dehydration step, for instance). Therefore, for very sensitive additives, post-conditioning introduction (soaking or coating after the pellets are made and cooled) is generally safer.
Co-extrusion and coating techniques: In more sophisticated manufacturing setups, one can incorporate additives during filament production using co-extrusion or post-extrusion coating. For example, a twin-screw extruder could be configured with a side feeder or injection port to introduce a heat-sensitive additive into the molten core of the filament at a late stage, or a coaxial nozzle could extrude a two-layer filament (with the additive concentrated in the core, surrounded by the PVA). Another method is to extrude the water-containing filament and immediately pass it through a bath or coating die containing the additive (especially useful for liquid additives) so that the filament picks up a surface layer of the additive. These approaches ensure the additive is incorporated without residing in the high-temperature zone for long. They require more complex equipment but demonstrate the flexibility of integrating the invention with advanced extrusion techniques.
Direct mixing at print time: It is worth noting that the material system is flexible enough that a user could mix the pellets and additives at the point of use. For instance, a hobbyist or technician might manually blend a measure of functional pellets with a measure of a powdered supplement or medication in the hopper of a pellet-fed 3D printer. The composite blend can then be fed directly into the printer's extruder. As it prints, the same protective mechanism occurs. This approach underscores that the invention does not necessitate pre-compounded filaments for every different additive; rather, a base functional carrier pellet could be paired with various additives on-demand, offering a modular platform for printing different functional objects as needed.

### 3D Printing Process With the Invention

Crucially, an advantage of this invention is that it enables printing of sensitive materials using standard FDM 3D printers with minimal modifications. Whether using a filament format (produced from the pellets and additive as described) or a direct pellet-feed format, the printing process largely follows the normal operation of the printer, with adjustments primarily to accommodate the release of water vapor.

If using filament, one would first extrude the composite (pellets+additive) through a filament-making extruder to produce a spool of filament. This extrusion can be done at a somewhat lower temperature than usual—for PVA, perhaps ˜170-180° C.—just enough to form a continuous filament without excessive bubbling, thereby preserving the additive as much as possible. This filament, containing the entrapped water and additive, can then be fed into any standard filament-based 3D printer. If using a pellet-fed printer (which some industrial machines or modified desktop printers allow), the conditioned pellets mixed with additive can be loaded directly into the printer's hopper.

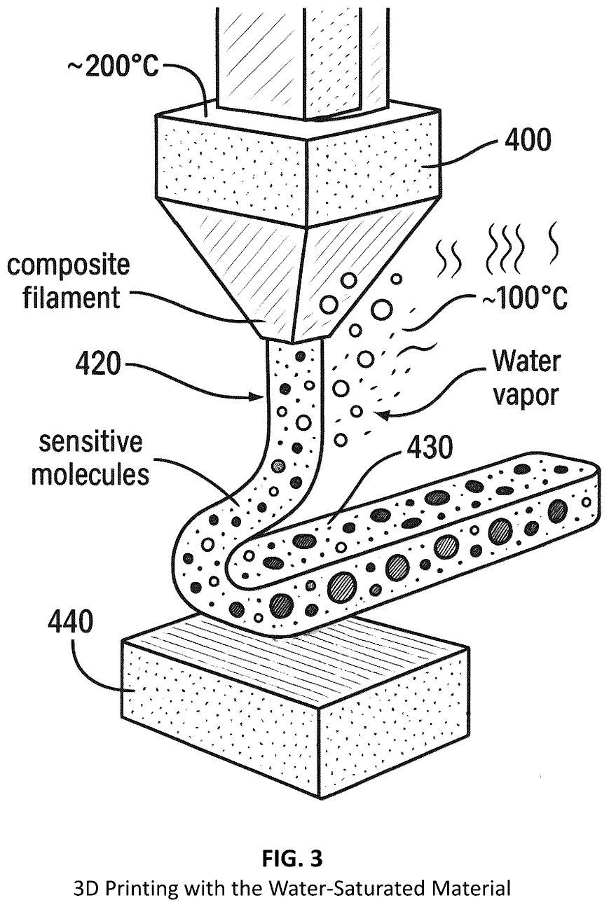

In either case, during printing, the printer's hot end is typically set around 190-210° C. (for PVA, ˜200 ° C. is common). As the composite material enters the hot nozzle and begins to melt, the water inside the material immediately starts to evaporate once the temperature exceeds 100° C. The evaporation of water is a strongly endothermic process (water's latent heat of vaporization is about 2260 J/g at atmospheric pressure), so as long as liquid water remains in the material, any additional thermal energy from the nozzle goes into converting that water to steam rather than raising the temperature of the polymer matrix. This means the polymer+additive mixture is effectively temperature-clamped around the boiling point of water (˜100 ° C.) in the region where mixing and flow occur. In practical terms, the sensitive molecules are kept near or below 100° C., well under typical degradation thresholds (for example, many enzymes or fragrances degrade above ˜120-150° C., which this process avoids). The water vapor generated forms bubbles within the molten polymer. Some of these micro-bubbles of steam may escape out of the nozzle alongside the extruded filament, and some may become small voids in the extruded strand (as depicted by 430 and 435 in FIG. 3). By the time the material filament exits the nozzle and is laid down on the build surface, most of the water has boiled off. The polymer, now mostly anhydrous, quickly solidifies (especially if cooling fans are used or once it contacts the cooler environment). The heat-sensitive additive, having been shielded from excessive heat, is now encapsulated in the solid polymer of the printed trace.

Because the additive never experienced the full nozzle temperature for any significant duration, it remains largely intact. For example, if an additive would normally denature at 150° C., in this invention it may never have been exposed to much above ˜100 ° C., and even brief excursions above 100° C. (if any small region temporarily superheats after the water is gone) are quickly mitigated by the surrounding boiling water or by the fact that the material is exiting the nozzle at that time. As a result, the printed part contains the functional molecules in an un-degraded, active state. The printed polymer matrix serves as a stable scaffold embedding those molecules.

There are some practical considerations during printing. The release of water vapor can produce pressure within the molten filament; if the printing is too fast or the nozzle too hot, the rapid boiling could cause foaming or “spitting” of material. To manage this, print parameters can be tuned. For instance, slightly slower print speeds can give the water more time to evaporate smoothly. The printer's retraction settings might be adjusted to avoid drawing steam into the nozzle between extrusion moves. In some cases, a modified nozzle design (for example, one with a small vent or a longer melt zone) could help vent steam or accommodate the expansion. However, in experiments to date, standard 0.4 mm nozzles have been used successfully with only minor parameter tweaks (detailed in the experimental section below).

One noticeable characteristic of prints made with water-containing filament is that the extruded material may contain tiny pores (micro-voids) left by the escaping steam. This typically manifests as a slightly porous texture in the printed object. In many cases, this is not detrimental; in fact, it can be beneficial depending on the application. For example, a bit of porosity in a printed soap bar can help it dissolve and lather more easily when used, and a porous drug-eluting implant can increase the surface area and thus the rate of drug release. The degree of porosity can be controlled to some extent by adjusting the initial water content and the printing parameters. Generally, it has been observed that the pores are very small (often not visible to the naked eye) and do not compromise the structural integrity of typical prints for their intended use. The overall dimensional accuracy and surface finish of prints can remain high, especially if printing is optimized (slower speeds, proper cooling, etc.). In summary, the ability to print at normal extrusion temperatures with minimal additive degradation is a breakthrough capability introduced by this material system, and any slight differences in printing behavior (like mild foaming or porosity) can be managed with standard printing optimizations.

### Ensuring Additive Integrity

Because the water evaporation mechanism is self-regulating in terms of temperature, the heat-sensitive additive is largely safeguarded throughout the extrusion. In essence, the water acts as an enthalpic buffer: it will continue to absorb energy (via phase change) as long as any liquid water remains in the mix, thereby preventing the internal temperature from spiking beyond the boiling point until the water is gone. For example, consider an additive that denatures at 150 2 C.—under this process, it likely never sees much above ˜100° C. while in the melt. Any attempt of the surrounding polymer to rise in temperature is countered by the endothermic vaporization of nearby water. Once the composite filament exits the nozzle and is deposited, it rapidly cools further (often solidifying in seconds), so the window of potential thermal damage is very short and mitigated by the latent heat cooling.

To further ensure the additive's integrity, the process can be tuned in various ways. The initial water content in the filament/pellet can be adjusted to make sure that enough water is present to protect the additive all the way until extrusion is complete. One wants sufficient water such that it hasn't all evaporated too early (while the material is still inside the nozzle)—otherwise the latter portion of the material could heat up unprotected. On the other hand, too much water could lead to excessive bubbling or overly porous material. Thus, an optimal range (as mentioned, roughly 10-40% internal moisture depending on circumstances) is targeted to balance protection and printability. If extremely temperature-sensitive molecules are being printed, the operator can also choose to lower the nozzle temperature slightly from standard (for instance, using 170-180° C. for PVA instead of ˜200 °° C.). PVA, especially when plasticized with water, can flow at these lower temperatures, so printing at the lower end of its range provides an extra safety margin for the additive. The presence of water effectively plasticizes the polymer melt, reducing its viscosity and allowing extrusion at lower temperatures and pressures than would be required for completely dry PVA. This is another advantage: the material can be extruded more gently, further preserving sensitive ingredients.

After printing, the finished object will typically contain little to no residual moisture. In many cases, the bulk of the water has already evaporated through the nozzle during the print. Any small amount remaining (especially if the object is large and was printed very rapidly, potentially trapping some steam in inner regions) will diffuse out or evaporate over time as the object sits. The printed item can be air-dried or mildly heated if one desires to remove all moisture. For applications like medical implants or electronics, one might dry the printed part in a desiccator or low oven to ensure no water is left. However, for other applications (like soap or nutritional items), a bit of remaining moisture may not be an issue or might even be desirable (e.g., a hydrated matrix). The key point is that the presence of water during printing is a transient means to protect the additive; it does not mean the final product is waterlogged (unless intentionally designed to be so).

In summary, by intelligently leveraging the phase-change cooling of water, the invention keeps sensitive additives below their damage thresholds throughout the printing process. The additives thus retain their structure and function in the printed object, which marks a substantial departure from what is possible with conventional 3D printing materials.

### Applicability and Variations

While the description has focused on PVA as the carrier polymer and water as the evaporative cooling agent, the inventive concept can be generalized. Any thermoplastic material that can incorporate a volatile substance (one that evaporates at a lower temperature than the polymer's extrusion temperature) could, in principle, be used to achieve a similar cooling effect. Water is an ideal choice in many respects: it has an exceptionally high latent heat of vaporization (providing strong cooling per unit mass), is safe and non-toxic, inexpensive, and environmentally benign. PVA happens to be an excellent host for water. However, other combinations are conceivable. For instance, other polar polymers or hydrogels could be used (polyvinylpyrrolidone, polyethylene glycol, certain starch-based plastics, etc.) as long as they can carry sufficient water or another coolant. It's also conceivable to use volatile organic liquids or physical blowing agents as the internal coolant—for example, a low-boiling hydrocarbon or refrigerant encapsulated in microcapsules within a filament, or even solid carbon dioxide (dry ice) powder mixed into a filament (which would sublime and cool upon heating). These alternatives, however, introduce additional complexity (organic solvents might be flammable or toxic; CO₂ requires pressure to stay solid and might gas out too quickly). Thus, water remains the most practical and preferred evaporative coolant for this application.

The invention is particularly useful for any scenario where functional additives are desired in a 3D print. By overcoming the thermal limitation, we marry the geometric freedom of 3D printing with the rich functionalities of chemical and biological additives. A non-exhaustive list of potential use-cases and products includes:
Pharmaceutical and biomedical printing: e.g., personalized medication tablets or capsules, printed on demand with a patient-specific drug dosage; drug-eluting stents or implants with embedded therapeutics; printed biosensors that contain enzymes or antibodies which remain active; tissue engineering scaffolds that include growth factors or even living cells that survive the printing.
Nutritional and food printing: e.g., 3D-printed nutritional supplements or vitamin gummies that incorporate heat-labile vitamins, probiotics, or flavors; printed food items (or food containers) that have encapsulated probiotics or nutrients which would normally be destroyed by cooking temperatures.
Cosmetics and personal care products: e.g., printable soap bars (as detailed later) that retain fragrances and moisturizers; printed shampoo or detergent shapes that dissolve in water; makeup or skincare products printed to custom shapes or doses with active ingredients (vitamins, botanical extracts) intact.
Aromatics and sensory items: e.g., scented ornaments, customizable air fresheners or diffuser shapes that contain essential oils (the printing ensures the shape, and the essential oils survive to provide aroma); educational models that incorporate encapsulated scents or flavors for demonstration purposes.
Bioactive materials for research or education: e.g., prints that contain enzymes and can catalyze reactions (for classroom demonstrations of biochemistry), or prints containing yeast or bacterial spores that can be revived (demonstrating living materials).
Temporary or degradable structures: The approach can also tie into 4D printing concepts—for instance, using water-rich filaments that gradually dissolve or change over time (the TimeMass Active filament line by the applicant is an example where time-controlled degradation is a feature, though that is a separate functional angle beyond just heat protection).

Overall, the ability to include a wide array of previously incompatible materials (due to heat sensitivity) in 3D printing opens the door to on-demand fabrication of multi-functional objects. This has broad implications across industries, from healthcare (patient-specific treatments) to consumer products (customized goods) to environmental sustainability (printing only what you need, with active functionality, reducing waste).

### Highlighting Novelty and Non-obviousness

To underscore the novelty of the invention, it is useful to contrast it with conventional wisdom in the field of FDM 3D printing. Previously, moisture in filament was considered a problem to be avoided. Users of 3D printers go to lengths to keep filaments dry (using desiccant boxes, filament dryers, etc.), because any absorbed water tends to vaporize in the hot end, causing foaming, nozzle sputtering, poor layer adhesion, and degraded mechanical properties in the print. A wet PVA filament, for example, would normally be expected to print very poorly—it would bubble and yield a weak, porous extrudate. Thus, it would seem counterintuitive to intentionally add water to a filament. The present invention turns that apparent drawback into a benefit by carefully controlling how much water is present and how it is retained. By using the multi-stage conditioning process and formulating the filament with the right internal water content, the invention harnesses the water's cooling effect without suffering the typical negatives of a soaked filament. This approach goes against the grain of standard practice, which is a strong indicator of its non-obviousness: it required recognizing that the latent heat of vaporization of water could be exploited to protect sensitive additives, and devising a material and method to do so reliably.

The multi-stage dehydration tower and pellet conditioning process described are unique steps that ensure the filament/pellets have the proper moisture distribution (wet inside, dry outside). This is not found in prior art for filament production. By implementing this, the inventors solved the handling problem (dry surface for feeding) while still delivering the cooling benefit (wet interior). The result is the first known method to FDM-print objects with functional heat-sensitive components intact, using the material's own internal phase-change (evaporation) as a cooling mechanism during extrusion. It is a pioneering approach in the field of additive manufacturing materials. The inventors believe no previous solution provides this capability of printing arbitrary heat-sensitive additives on standard high-temperature printers. The surprising nature of the solution—using moisture, traditionally an enemy of FDM printing, as the key to enabling new functionality—highlights the inventive step. This approach opens a fundamentally new pathway to create 3D printed products that are functionally as well as structurally complex.

### Experimental Example and Results

The principles of the invention have been tested in practice on several prototype materials and sample printed objects, yielding promising results that demonstrate both feasibility and the preservation of functionality in the printed additives. In fact, the applicant's company (String Cubed Inc.) has by now developed and successfully printed over ten distinct functional 3D printing filament formulations (marketed under its TimeMass™ portfolio) based on this water-rich carrier system. These include filaments incorporating active pharmaceuticals, nutraceuticals, essential oils, color-changing dyes, plant-derived materials, antimicrobial agents, and more. The broad range of additives tested attests to the generality and industrial applicability of the invention. One signature product enabled by this technology is a soap-based 3D printing filament that is believed to be a world first: a filament that can be printed into a usable bar of soap while maintaining the soap's cleansing functionality, surfactant structure (foaming ability), and fragrance after printing. This filament (commercially known as TimeMass Soap) exemplifies the invention's capability and serves as a showcase for the system.

Soap Filament Example: In one experiment, a batch of PVA was saturated with water and conditioned according to the method of the invention, then mixed with a concentrated soap formulation. The soap formulation included typical soap ingredients such as surfactants (cleansing agents), glycerin, and essential oil fragrances—all of which are ordinarily quite sensitive to high heat (for instance, fragrances evaporate or “burn off” and many surfactants decompose or char at temperatures near 200° C.). The water-loaded PVA with the soap additives was extruded into a 1.75 mm filament (using an extruder temperature of about 180° C. to minimize any pre-release of fragrance). This filament was then used as feedstock to 3D-print small soap bars in various novelty shapes (each roughly 5-8 cm in size) on a standard desktop FDM printer with a nozzle temperature of approximately 195° C. During the printing process, a modest amount of steam was observed emanating from the nozzle area—a visible confirmation that water was indeed vaporizing to cool the material. The printing proceeded smoothly aside from this slight vapor release.

After printing, the soap objects were allowed to cool and then tested. By all qualitative measures, the 3D-printed soap bars behaved like normal soap. They retained their fragrance (users could smell the intended essential oil scent, with no burnt odor) and, when put into use with water, they lathered and foamed properly to cleanse the skin. In other words, the surfactant structure responsible for foaming had survived the printing. The printed soap's texture was solid and smooth, indistinguishable in appearance from a conventional molded soap bar except for a faint pattern from the 3D printing layers. If the active soap ingredients had been destroyed by the heat of extrusion, the printed bars would not lather or would have lost their fragrance—but testers reported that the lather quality and scent were on par with store-bought soap. This experiment thus provides a clear proof-of-concept that heat-sensitive functional molecules (in this case, soap surfactants and fragrance compounds) remained intact due to the protective water-cooling mechanism of the carrier. Notably, this 3D printable soap filament is a flagship product demonstrating the invention's capabilities—it is believed to be the first time a true soap (with real cleaning power and foam) has ever been produced via 3D printing, which garnered significant interest as a novelty and a potential customizable consumer product.

Beyond soap, numerous other formulations were tested:
In one trial, a cinnamon-infused filament was produced (using PVA, water, and natural cinnamon powder as an additive) to create aromatic objects. When printed, the resulting pieces emitted a distinct cinnamon aroma, indicating that the volatile flavor compounds in cinnamon (which would normally be destroyed or evaporated at high temperature) were largely preserved. For comparison, a control print made by mixing cinnamon powder into a standard PLA plastic (with no water cooling) resulted in a very faint scent, as most of the aromatics were likely lost to the heat.
In another trial, a heat-sensitive organic dye was added to the water-PVA matrix to test color preservation. The printed object exhibited the bright, intended color of the dye. A control sample (printing the same dye in a regular PLA filament without water) showed significant discoloration/browning of the dye due to thermal degradation. This again confirmed that the invention's cooling effect can prevent chemical breakdown of additives.
Additional prototypes included a filament loaded with a probiotic bacterial powder (which was printed into a soluble capsule shape—post-print analysis showed that a portion of the bacteria survived, which would be impossible if they were exposed to 200° C. without protection) and a filament containing plant seeds and nutrients (printed into a structured pod for agriculture use—the seeds remained viable after printing).

In total, over ten different functional filament compositions have been developed and test-printed using this water-based carrier system, as mentioned. These span use-cases in cosmetics, food, pharma, and even electronics (e.g., a trial with a temperature-sensitive conductive ink encapsulated in a filament). All these examples underscore the wide applicability of the approach.

User Feedback and Performance: Many of the printed items (such as the soap bars and scented objects) were given to testers or customers to use in real-life conditions. The feedback uniformly indicated that the printed objects performed their intended functions. The soap cleaned and foamed, the scented items smelled pleasant, the vitamin-enriched samples dissolved and presumably released their nutrients, etc. This kind of functional validation—coming directly from user experience—strongly supports the effectiveness of the invention. It demonstrates that, at least qualitatively, the heat-sensitive components are surviving the 3D printing process in usable form.

It is important to note that, to date, the evidence is primarily qualitative and functional (e.g., “does it smell right?”, “does it foam?”, “does it still fluoresce or conduct electricity?”). Precise quantitative measurements of residual active content (for instance, using chemical analysis to determine the percentage of a drug that remains active after printing) are ongoing and form part of continued R&D. However, the functional outcomes speak for themselves and are not easily explained away except by concluding that the sensitive molecules were not destroyed.

Optimization and Practical Tips: During these experiments, certain practical adjustments were made to optimize print quality when using water-containing filaments:
Print speed was sometimes reduced (for example, printing at 80% of the normal speed for PVA) to allow the water sufficient time to boil off gently, thereby minimizing any pressure buildup that could cause the filament to splutter. Slower extrusion ensured a smooth flow of material despite the outgassing of steam.
It was found beneficial to keep the filament (or pellets) sealed in a bag or container until just before printing. This prevented the material from drying out excessively in ambient air, which would reduce its protective water content. Conversely, it also prevented the material from picking up too much ambient moisture on very humid days, which could upset the balance. In essence, maintaining a consistent moisture level from preparation to printing was important for repeatable results.
The printed objects, as mentioned, exhibited a slight porosity due to the released water. For example, printed soap bars were measured to be a few percent lighter in weight than an equivalently sized solid bar, indicating some porosity. This was not visible as holes, but the bars would float in water (whereas a completely dense PVA object might sink). In the context of soap, this was actually a neutral or positive attribute—it did not detract from the user experience, and may have helped the soap dry between uses. In other contexts, if porosity is undesirable, it could potentially be reduced by adjusting the formulation (perhaps using a bit less water and a little higher nozzle temperature, trading off some cooling for density).
Standard printer calibration steps (such as retraction tuning to avoid stringing) had to be revisited because the presence of moisture can slightly alter the viscosity and flow characteristics of the filament. Minor tweaks to retraction distance and speed, as well as ensuring the printer's part-cooling fan was tuned appropriately (too much cooling air could solidify the filament before all water escaped, for instance), were part of refining the print profiles for these new materials.

In summary, these real-world trials and demonstrations provide strong validation that the invention works as intended: by using a water-saturated polymer carrier, one can successfully 3D print objects containing functional, heat-sensitive ingredients that remain active in the finished product. This outcome is something that cannot be achieved with conventional dry thermoplastic filaments, underscoring the novelty and significance of the invention. The fact that a broad spectrum of additives (from fragrances to live cells to pharmaceuticals) have been printed in this manner speaks to the robustness and versatility of the approach. The invention thus enables a new class of “functional filaments” (exemplified by the TimeMass product line) for commercial and experimental use, opening up myriad possibilities for advanced 3D-printed products.

### Scope of the Invention

The above claims outline various aspects of the invention, including the material composition, the manufacturing process, and the resultant printed product. It should be understood that the scope of the invention is not limited to the specific examples given herein. Many modifications and variations can be made by those skilled in the art without departing from the spirit of the invention. For instance, different polymers capable of carrying water, different volatile cooling agents, or different types of heat-sensitive inclusions could be employed in lieu of the examples provided, while still achieving the core cooling-and-protection function. The inventors contemplate all such variations as falling within the scope of the inventive concept. Given that this is a pioneering approach (believed to be the first of its kind), the claims are intended to be construed broadly, with the novel feature being the use of an internal phase-change cooling mechanism (e.g., water evaporation within the material) to enable high-temperature extrusion printing of materials that would otherwise be destroyed by those temperatures. By overcoming the longstanding thermal limitations of current 3D printing materials, the invention is poised to unlock a broad new range of functional 3D printing applications.

1. A 3D-printable material composition for forming objects containing heat-sensitive molecules, the composition comprising: a polar thermoplastic polymer matrix having an internal water content sufficient to evaporatively cool the composition during extrusion; and one or more heat-sensitive molecules distributed in the polymer matrix; wherein the water content in the polymer matrix is retained within the matrix prior to extrusion and is released as water vapor when the composition is heated during 3D printing, thereby absorbing heat and preventing the heat-sensitive molecules from being denatured or destroyed by the extrusion temperature.

2. The 3D-printable material of claim 1, wherein the polar thermoplastic polymer is polyvinyl alcohol (PVA) that has been highly hydrolyzed and saturated with water to form a water-rich hydrogel prior to combination with the heat-sensitive molecules.

3. The 3D-printable material of claim 1 or 2, wherein the water content of the polymer matrix is between 5% and 50% by weight, and the polymer matrix has a dried outer surface and a moisture-containing interior.

4. The 3D-printable material of any of claims 1-3, wherein the heat-sensitive molecules are selected from the group consisting of: proteins, peptides, enzymes, amino acids, pharmaceuticals, vitamins, probiotics or living cells, fragrances or essential oils, and other organic compounds that degrade at temperatures above 150 ° C.

5. A method of preparing a 3D printing feed material that enables extrusion of heat-sensitive components without thermal damage, the method comprising: (a) saturating a quantity of a water-absorbing thermoplastic polymer with water to form a water-infused polymer; (b) forming the water-infused polymer into pieces suitable for feeding into a 3D printer, wherein the pieces retain water internally; (c) partially drying an exterior of said pieces while maintaining an interior water content, including using a multi-stage drying process in which lower portions of the pieces are heated to release water vapor that is absorbed by upper portions, thereby producing conditioned pieces that have a moisture-rich core and a solid outer surface; (d) after cooling, combining the conditioned pieces with one or more heat-sensitive molecules to form a composite mixture; and (e) extruding or printing the composite mixture through a 3D printer at an extrusion temperature above 150 ° C., whereby water within the composite mixture vaporizes during step (e) and absorbs heat such that the heat-sensitive molecules are kept below their thermal degradation temperature during the extrusion.

6. The method of claim 5, wherein in step (a) the thermoplastic polymer is polyvinyl alcohol (PVA) powder and the saturation is achieved by mixing the PVA with 50-80% by weight water to create a gel.

7. The method of claim 5, wherein step (c) is performed in a dehydration tower comprising multiple perforated trays with a temperature gradient from bottom to top, such that lower pieces are heated to about 100-130 ° C. to drive off moisture which is carried upward and absorbed by upper pieces at about 50-80 2 C., resulting in pieces that have about 10-40% internal water content and a non-tacky surface.

8. The method of claim 5, further comprising extruding the composite mixture of step (d) into a filament before step (e), wherein the filament contains trapped water and the heat-sensitive molecules and is used as the feedstock in a filament-based 3D printer in step (e).

9. The method of claim 5, wherein the heat-sensitive molecules comprise a soap formulation including surfactants and fragrances, and wherein the printed object produced in step (e) is a soap article that retains its fragrance and cleaning ability, indicating that the surfactants and fragrances were not destroyed by heat during printing.

10. A 3D-printed object produced by the method of claim 5, comprising a matrix of a thermoplastic polymer and one or more functional heat-sensitive additives embedded therein, wherein the object is produced by an extrusion-based additive manufacturing process and the functional additives retain at least a portion of their intended activity (such as therapeutic effect, scent, enzymatic activity, or similar functionality) as a result of being protected from thermal degradation during printing by evaporative cooling of internal water in the material.

11. The 3D-printed object of claim 10, wherein the object is a drug-eluting medical implant, a consumable or soluble product selected from the group consisting of a soap or a pill, or a personalized dosing unit, and wherein the active ingredient in the object remains effective after the printing process.
